(19) United States
(12) Patent Application Publication
(10) Pub. No.: US 2012/0234247 A1
(43) Pub. Date: Sep. 20, 2012

(54) Energy Efficient Heated Pet Pad

(75) Inventors: Jason R. GRAVES, Knoxville, TN (US); Marc E. Brush, Knoxville, TN (US); Ben T. Ferguson, III, Knoxville, TN (US); Richard Bruer, Knoxville, TN (US)

(73) Assignee: Radio Systems Corporation, Knoxville, TN (US)

(21) Appl. No.: 13/048,555

(22) Filed: Mar. 15, 2011

(51) Int. Cl. A01K 29/00; B23P 11/00

(52) U.S. Cl. 119/28.5; 29/428

(57) ABSTRACT

A heated pet pad having a substantially oval shape and including a heating element to produce heat within the pet pad, a reflective layer mounted adjacent to the heating element to reflect heat toward the animal, and a support layer to contain the heating element and the reflective layer within the pet pad, the support layer including a plurality of support members extending from a first surface thereof to simulate a mattress spring, and a plurality of feet members extending from an opposite surface of the support layer to raise the pet pad off the external ground surface to inhibit heat loss.

### BACKGROUND

1. Field of Inventive Concept

The present general inventive concept relates generally to pet pads, and more particularly, to a contoured and heated pet pad which is structured for energy and space efficiency as well as comfort for the pet.

2. Description of the Related Art

There are several designs of heated pet pads on the market that provide warmth and comfort for pets indoors or outdoors. These designs range from soft foam heated beds intended for indoor use to rigid, durable, water resistant pads intended for outdoor use. One drawback of existing designs is that they are not very energy efficient. This is especially the case for outdoor heated pads being used in cold weather because in most cases, a significant portion of the heat is lost to the cold surface that the pad is laying on (e.g., concrete, wood, ground, etc.) as well as the surrounding air. Further, existing pet pads are less than satisfactory in providing a space efficient structure which is capable of being fit into rectangular dog houses and kennels as well as round dog houses (e.g., igloos) without having significant amounts of wasted space and without losing significant amounts of heat to the surrounding air. Most other pads of this type are rectangularly shaped, and it is difficult for a pet to lie in such a way to cover the entire pad, namely the 4 corners, thus allowing heat to be lost and not transferred to the pet.

### SUMMARY

The present general inventive concept provides a contoured and heated pet pad which is structured for energy efficiency, warmth, and comfort for the animal, and which is capable of being conveniently fit into dog houses or other designated pet areas without having significant amounts of wasted space.

Some embodiments of the present general inventive concept provide a durable, water-resistant heated pet pad that can be used outdoors and is more energy efficient than other known designs, is comfortable for the pet, and is able to fit into most dog houses and kennels.

Additional features and embodiments of the present general inventive concept will be set forth in part in the description which follows and, in part, will be obvious from the description, or may be learned by practice of the general inventive concept.

Example embodiments of the present general inventive concept can be achieved by providing a heated pet pad having a substantially oval shape to better conform to an animal's body, including a heating element to conduct and radiate heat to the pet pad, a reflective thermally conductive layer mounted adjacent to the heating element to reflect radiant heat toward the animal and to distribute the heat more evenly throughout the pet pad through conduction, and a support layer to enclose the heating element and the reflective layer within the pet pad including a plurality of support members extending from a first surface of the support layer toward a contoured upper layer to simulate a mattress spring for the heated pet pad, and a plurality of feet members extending from an opposite surface of the support layer to raise the pet pad from an external contact surface to insulate the pet pad from the contact surface.

The contoured layer can include a convex surface which can flex against the weight of a pet until the convex surface contacts one or more of the support members and returns to its original convex shape when the pet leaves the pet pad. The contoured layer also allows water and pet urine to drain off the pad, keeping the pad dry.

The oval shape can be dimensioned to substantially correspond to the size of a pet to enhance heat transfer from the pet pad to the pet.

The heating element can include a temperature controller to disable the heating element when a temperature of the heating element exceeds a predetermined threshold.

The heated pet pad can include a temperature controller to monitor the ambient temperature to activate the heating element when the ambient temperature is below a predetermined threshold.

The heated pet pad can include an insulating layer disposed adjacent the reflective layer and opposite the heating element to insulate the heating element and minimize heat wasted through convection and conduction to the lower housing.

Example embodiments of the present general inventive concept can also be achieved by providing a method of making a heated pet pad, including providing a contoured layer having a substantially oval shape, mounting a heating element to the contoured layer in a spaced apart manner about an inner area of the contoured layer, mounting a reflective thermally conductive layer adjacent to the heating element and opposite the contoured layer to reflect radiant heat from the heating element toward the contoured layer and distribute the heat more evenly throughout the pet pad through conduction, and connecting a support layer having an oval shape approximately the same as the contoured layer to the contoured layer such that the heating element and the reflective layer are enclosed within a space between the support layer and the contoured layer, the support layer having a plurality of support members extending through the space toward the contoured layer and a plurality of feet members extending from an outer surface of the support layer to raise the pet pad with respect to an external support surface.

### BRIEF DESCRIPTION OF THE SEVERAL VIEWS OF THE DRAWINGS

The following example embodiments are representative of exemplary techniques and structures designed to carry out the present general inventive concept, but the present general inventive concept is not limited to these example embodiments. Additional embodiments and/or features of the present general inventive concept will become more clearly understood from the following detailed description in conjunction with the accompanying drawings in which:

FIG. 1 is a perspective view of a contoured heated pet pad in use by a pet in accordance with an example embodiment of the present general inventive concept;

FIG. 2 is an exploded bottom isometric view of a contoured heated pet pad configured in accordance with an example embodiment of the present general inventive concept;

FIG. 3 is a detail view of attachment structures provided on an inner surface of the pet pad to affix a heated element and a power cord to an exemplary heated pet pad according to an example embodiment of the present general inventive concept;

FIG. 4 is a top plan view of a contoured heated pet pad configured in accordance with an example embodiment of the present general inventive concept;

FIG. 5 is a bottom plan view of the exemplary contoured heated pet pad of FIG. 4; and

FIG. 6 is a cross-section view of the exemplary contoured heated pet pad of FIG. 4, taken across line 6-6 of FIG. 4, with certain details of the inner chamber omitted for clarity.

### DETAILED DESCRIPTION

Reference will now be made to various exemplary embodiments of the present general inventive concept, examples of which are illustrated in the accompanying drawings, wherein like reference numerals refer to like elements throughout. The following description of the various embodiments is merely exemplary in nature and is in no way intended to limit the present general inventive concept, its application, or uses. The example embodiments are merely described below in order to explain the present general inventive concept by referring to the figures. It is noted that in the accompanying drawings and illustrations, the sizes and relative sizes, shapes, and qualities of lines, entities, and regions may be exaggerated for clarity and/or convenience of illustration.

Throughout the following description, spatially relative terms, such as “up,” “down,” “right,” “left,” “beneath,” “below,” “lower,” “above,” “upper” and the like, may be used for ease of description to describe one element or feature's relationship to another element(s) or feature(s) as illustrated in the figures. It will be understood, however, that these spatially relative terms are intended to encompass different orientations of the device in use or operation in addition to the orientation depicted in the figures, and are provided for convenience of description only with reference to the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

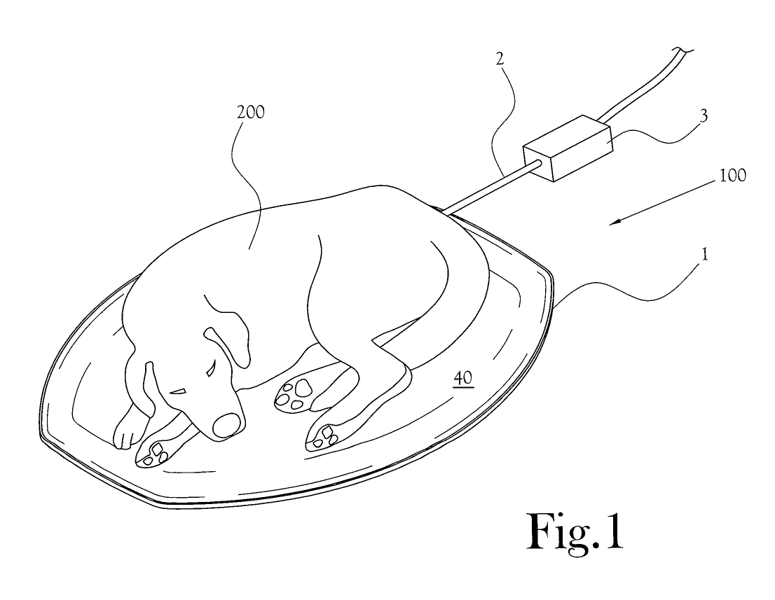

With reference now to the drawings, and in particular FIG. 1, there is illustrated an exemplary contoured heated pet pad 100 in use by a pet 200 according to an example embodiment of the present general inventive concept. The pet pad 100 can be formed in a generally oval shape to match the shape of the pet's core body, especially when the pet is curled-up as most pets do when sleeping as illustrated in FIG. 1.

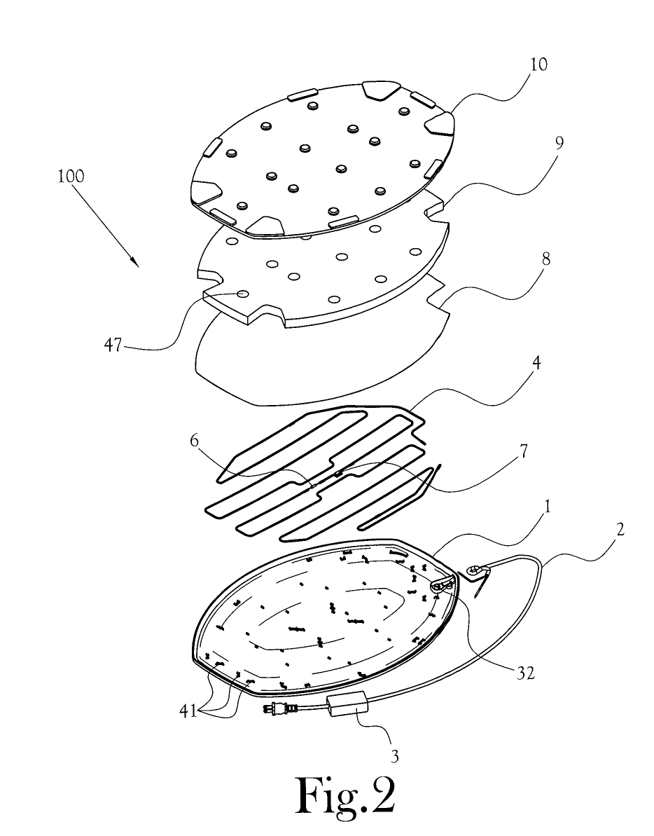

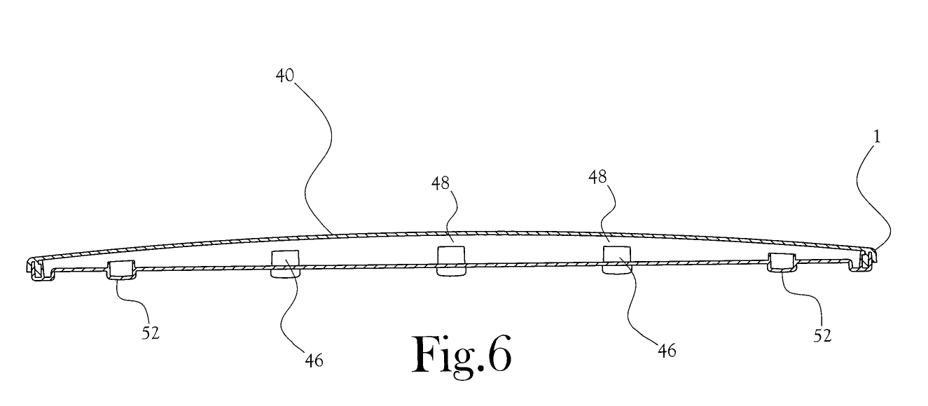

FIG. 2 is an exploded bottom isometric view of the exemplary pet pad 100 configured in accordance with an example embodiment of the present general inventive concept. The exemplary heated pet pad 100 can include a plurality of layers including an upper housing 1, an electrical heating element 4, a reflective thermally conductive element 8, a thermal insulation layer 9, and a lower housing 10. It is possible for the foregoing components to be formed as individual units or to be to be integrated as a single unit or various combinations of sub-units. By way of example and not by way of limitation, it is possible for the thermal insulation layer 9 and the lower housing 10 to be formed as a single support layer or unit. The thermal insulation layer 9 can include a plurality of holes 47 to provide clearance for a plurality of support pillars 46 which extend from the lower housing toward the upper housing 1 (FIG. 6). Other combinations and sub-combinations of the various components are also possible without departing from the broader scope and spirit of the present general inventive concept.

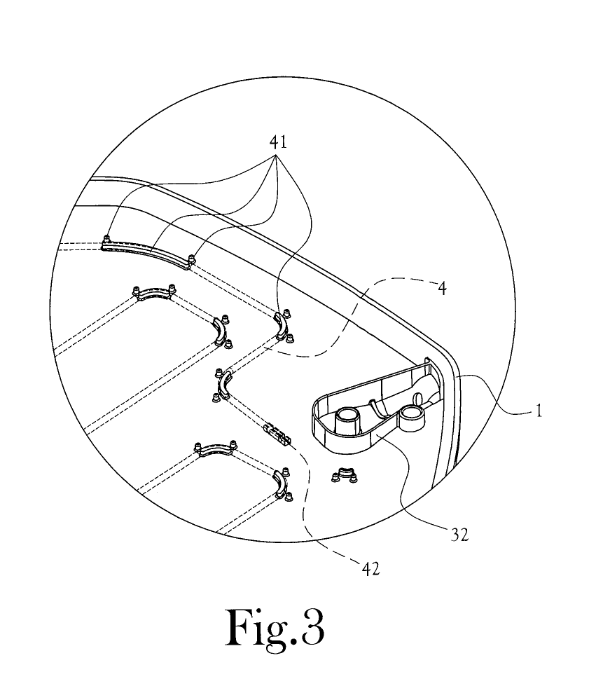

As illustrated in FIG. 2, the upper housing 1 can have a power cord 2 connected thereto to deliver electrical power to the electrical heating element 4. The power cord 2 and electrical heating element 4 can be affixed to the upper housing 1 by fastening features, by the adhesive lined reflective thermally conductive element, or other means chosen with sound engineering judgment. For example, the power cord 2 can be connected to the pet pad 100 via a power cord retaining member 32 and the heating element 4 can be affixed using attachment members 41, as illustrated in FIG. 3. The power cord 2 can also be glued with various adhesives to provide strain relief and water-tightness. It is noted that the pet pad 100 could alternatively include batteries or other forms of power supplies besides electric power delivered via a power cord 2 to energize the heating element 4 without departing from the broader scope and spirit of the present general inventive concept.

FIG. 3 illustrates an exemplary arrangement to affix the heating element 4 to the upper housing 1 including a plurality of attachment members 41 provided on an inner surface of the upper housing 1. In this example embodiment, the attachment members 41 can take the form of arcuate attachment members and pegs 41 configured in shape and size to snap or clamp the heating element 4 in a spaced apart manner about substantially an entire inner area of the upper housing 1 to conduct and radiate heat to the upper housing 1. The upper housing 1 can include a power cord retaining member 32 to facilitate connection of the power cord 2 to the upper housing 1 to deliver electrical power to the heating element 4. For example, the power cord 2 can be installed to the retaining member 32 using a strain-relief device to securely connect the power cord 2 to a terminal end 42 of the heating element 4. While the upper housing 1 is not limited to any particular type of material, the upper housing 1 can be formed of an injection molded plastic such as ABS, HIPS, PVC, or PP. The electrical heating element 4 can take the form of a resistive heating wire to provide heat when energized by electrical power delivered by the power cord 2.

Referring back to FIG. 2, the electrical heating element 4 can include a thermostat 7, such as an electomechanical thermostat, to regulate the temperature of the heating element 4 and pad 100 within a specified range. In one embodiment, the heating element 4 can include a thermal fuse 6 to disable the heating element 4 if the temperature within the pad 100 exceeds a predetermined temperature, for example, in case the product becomes damaged or misused. Positioned below the heating element 4 can be a reflective element 8 having a similar oval shape to reflect and distribute heat from the heating element 4 uniformly throughout the pet pad 100. In one embodiment, the reflective element 4 can take the form of a sheet of reflective aluminum foil that is secured in place between the thermal insulation layer 9 and the heating element 4 by way of adhesive on the reflective side of the sheet. The aluminum sheet can help distribute heat uniformly throughout the pet pad 100 to reduce “hotspots” and the adhesive lined sheet securely holds the wire in place. The reflective surface of the foil can reflect radiant heat from the heating element 4 back up toward the upper housing 1 and pet 200.

The pet pad 100 can include a layer of thermal insulation 9 positioned below the reflective element 4, such as fiberglass, foam, air bubble sheet, and the like, to insulate the heating element 4 from the lower housing 10 and to minimize heat wasted by convection and conduction to the lower housing and effectively the ground. In some embodiments, the heating element 4, reflective element 8, and insulation layer 9 can be contained in the assembly of FIG. 2 by assembling the lower housing 10 to the upper housing 1 such that a water-tight seal is applied around the periphery of the housings using methods such as adhesives, ultrasonic welding, hot plate welding, screws with gaskets, or other means chosen with sound engineering judgment. While the lower housing 10 is not limited to any particular type of material, the lower housing 10 can be formed of an injection molded plastic such as ABS, HIPS, PVC, or PP.

Referring to FIG. 2, an ambient temperature sensing controller 3 can be connected inline with the power cord 2. In one embodiment, the ambient temperature sensing controller 3 can measure the ambient temperature of the surrounding air and can automatically turn OFF or ON power to the pet pad 100 when the surrounding temperature is above or below a predetermined threshold temperature. For example, if the surrounding air temperature is above a specified temperature, the ambient temperature sensing controller 3 can turn off power to the pet pad 100 in order to conserve energy during warm periods. While the ambient temperature controller 3 is not limited to any particular configuration, in one embodiment, the controller 3 could take the form of an electromechanical thermostat with a fixed temperature setting (for example: 32° F.) that is wired inline to the power cord 2 and contained within a water-tight plastic injection molded housing. In other embodiments, the controller 3 could contain a control circuit mechanism that allows a user to adjust the threshold temperature set point through a mechanical interface such as a dial or an electrical interface such as an LCD display with buttons that is sealed in a water-tight plastic injection molded housing. The ambient temperature sensing controller 3 can monitor the temperature of the ambient environment and allow operation of the pad when the ambient is below a set temperature point. This allows the pad to be more energy efficient by not operating whenever the outside temperature is warm enough for the pet. Note that the ambient temperature sensing controller 3 can also be designed to cut power on at a separate temperature than it cuts power off using any of the previously described methods. For example, it is possible the controller 3 could cut the power on at temperatures below 32° F. and cut the power off at temperatures above 45° F. This prevents the controller from cycling continuously when the ambient temperature is at or near the controller temperature setting and can extend the life of the controller.

FIG. 4 is a top plan view of a contoured heated pet pad configured in accordance with an example embodiment of the present general inventive concept. As illustrated in FIG. 4, the peripheral surface of the pet pad 100 can be formed in a generally oval shape to match the shape of an animal's core body, especially when the animal is curled-up as most pets do when sleeping, as illustrated in FIG. 1. The oval shape also enables the pet pad 100 to be conveniently installed into dog houses or other confined areas without wasting significant amounts of space. For example, the pet pad 100 can be installed into rectangular dog houses as well as round dog houses (e.g., igloos) without having significant amounts of wasted space while conforming to the core shape of the animal's body when the animal is lying on the pet pad 100, facilitating efficient heat transfer to the animal.

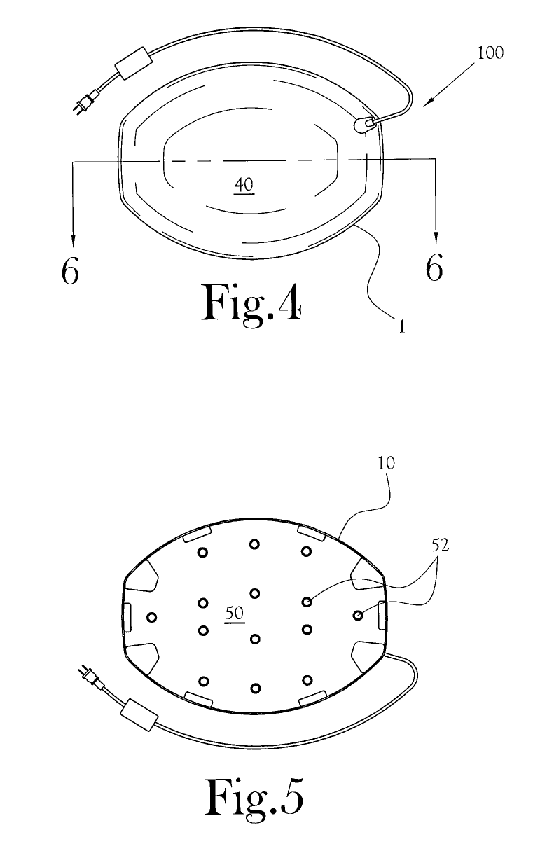

FIG. 5 is a bottom plan view of an exemplary contoured heated pet pad configured in accordance with an example embodiment of the present general inventive concept. As illustrated in FIG. 5, the lower housing 10 can include a plurality of feet members 52 extending from a bottom surface 50 of the lower housing to raise the bottom surface 50 off the ground or other external support surface to reduce the conductive heat lost to the ground during operation of the pet pad 100. That is, the heated pet pad 100 can be raised and insulated from the ground surface to reduce heat loss to the ground.

FIG. 6 is a cross-section view of the exemplary contoured heated pet pad of FIG. 4, taken across line 6-6 of FIG. 4. The top surface 40 of the upper housing 1 can be contoured in a generally convex manner. Referring to FIG. 6, a plurality of support pillars 46 can be provided on the lower housing 10 to extend below an inner surface of the upper housing 1 to provide a built-in spring mechanism into the upper housing without using additional parts. For example, the upper housing 1 can simulate a mattress spring such that when a pet is lying on the convex surface 40, the surface 40 can deflect, or flex, against the weight of the pet until the inner surface flexes down past the air gap 48 and hits the support pillars 46. When the pet leaves the pet pad 100, the top surface 40 will return to its original convex shape. This flexing action provides additional comfort to the dog by simulating a mattress spring using an integrated structure to reduce the number of parts required in a cost-effective manner.

Note that the simplified diagrams and drawings do not illustrate all the various connections and assemblies of the various components, however, those skilled in the art will understand how to implement such connections and assemblies, based on the illustrated components, figures, and descriptions provided herein. It is also noted that numerous variations, modifications, and additional embodiments are possible, and accordingly, all such variations, modifications, and embodiments are to be regarded as being within the spirit and scope of the present general inventive concept. Regardless of the content of any portion of this application, unless clearly specified to the contrary in the description or claims, there is no requirement for the inclusion in any claim herein or of any application claiming priority hereto of any particular described or illustrated activity or element, any particular sequence of such activities, or any particular interrelationship of such elements.

While the present general inventive concept has been illustrated by description of several example embodiments, it is not the intention of the applicant to restrict or in any way limit the scope of the general inventive concept to such descriptions and illustrations. Instead, the descriptions and drawings herein are to be regarded as illustrative in nature, and not as restrictive, and additional embodiments will readily appear to those skilled in the art in view of the foregoing description, accompanying drawings, and appended claims.

What is claimed is:

1. A heated pet pad, comprising:
a contoured layer having a substantially oval shape;
a heating element mounted to the contoured layer and disposed in a spaced apart manner about an inner area of the contoured layer;
a reflective layer mounted adjacent to the heating element and opposite the contoured layer to reflect heat from the heating element toward the contoured layer; and
a support layer having an oval shape approximately the same as the contoured layer and affixed to the contoured layer such that the heating element and the reflective layer are enclosed within a space between the support layer and the contoured layer, the support layer having a plurality of support members extending through the space toward the contoured layer and a plurality of feet members extending from an outer surface of the support layer to raise the pet pad with respect to an external support surface.

2. The heated pet pad of claim 1, wherein the contoured layer includes a convex surface which flexes against the weight of a pet until the convex surface contacts one or more of the support members and returns to its original convex shape when the pet leaves the pet pad.

3. The heated pet pad of claim 1, wherein the plurality of feet members create a heat insulation layer between the support layer and the external support surface to inhibit heat loss to the external support surface.

4. The heated pet pad of claim 1, wherein the oval shape is dimensioned to substantially correspond to the size of a pet to enhance heat transfer from the pet pad to the pet.

5. The heated pet pad of claim 1, wherein the reflective layer defines an oval shape approximately the same as the contoured layer.

6. The heated pet pad of claim 1, wherein the heating element includes a temperature controller to disable the heating element when a temperature of the heating element exceeds a predetermined threshold.

7. The heated pet pad of claim 1, wherein the heating element includes a controller to monitor the ambient temperature to activate the heating element when the ambient temperature is below a predetermined threshold.

8. The heated pet pad of claim 1, further comprising:
an insulating layer disposed adjacent the reflective layer opposite the heating element to insulate the heating element and to minimize heat lost to an external support surface.

9. The heated pet pad of claim 1, wherein the support layer and the contoured layer form a water-tight seal therebetween.

10. The heated pet pad of claim 2, further comprising:
an insulating layer having a plurality of holes to receive the plurality of support members and disposed adjacent the reflective layer opposite the heating element to insulate the heating element and to minimize heat lost to an external support surface,
wherein the reflective layer defines an oval shape approximately the same as the contoured layer and the plurality of holes are disposed opposite the plurality of feet members.

11. A method of making a heated pet pad, comprising:
providing a contoured layer having a substantially oval shape;
mounting a heating element to the contoured layer in a spaced apart manner about an inner area of the contoured layer;
mounting a reflective layer adjacent to the heating element and opposite the contoured layer to reflect heat from the heating element toward the contoured layer; and
connecting a support layer having an oval shape approximately the same as the contoured layer to the contoured layer such that the heating element and the reflective layer are enclosed within a space between the support layer and the contoured layer, the support layer having a plurality of support members extending through the space toward the contoured layer and a plurality of feet members extending from an outer surface of the support layer to raise the pet pad with respect to an external support surface.
